(19) United States
(12) Patent Application Publication
(10) Pub. No.: US 2017/0198523 A1
(43) Pub. Date: Jul. 13, 2017

(54) LADDER ACCESSORIES

(71) Applicant: Anthony Leo Klein, Freeport, NY (US)

(72) Inventor: Anthony Leo Klein, Freeport, NY (US)

(21) Appl. No.: 14/992,830

(22) Filed: Jan. 11, 2016

(51) Int. Cl. E06C 7/48

(52) U.S. Cl. CPC E06C 7/48

(57) ABSTRACT

Mitts, boots or pads are formed from a deformable material, such as foam and/or memory foam and/or gel filled for more protection of walls. When the mitts are disposed on the ends of the rails of the ladder, and the ladder is placed against a wall, the mitts help prevent damage to the wall or building by the ladder. The mitts can help prevent damage to any building surface, such as acrylic, stucco, siding, aluminum window and fascia capping, gutters, soft wood, sheetrock, painted or stained surfaces, and the like. The mitts can include an outer covering with enhanced friction properties that can help grip the structure upon which the ladder is placed. A ladder protection pad may also be used on any type of wall, where the larger the pad the more protection due to the fact that ladder and the user's weight are displaced over a larger area.

### CROSS-REFERENCE TO RELATED APPLICATIONS

This application claims the benefit of priority of U.S. Provisional patent application No. 62/078,948, filed Nov. 12, 2014, the contents of which are herein incorporated by reference.

### BACKGROUND OF THE INVENTION

The present invention relates to ladder accessories and, more particularly, to an mitt or boot that can fit on a ladder top or on ends of ladder stabilizer bars as well as weights for lowering the center of gravity of a ladder in use.

Ladders are frequently used by placing the ends of the rails of the ladder against a structure, such as a house or building. The ends of the rails of the ladder are often formed of aluminum or hard plastic, for example. These ends can damage the building and may also be prone to slipping along the side of the building.

To help overcome the inherent instability of a straight ladder, ladder stabilizers have been developed that extend from the sides of the ladder, creating a larger footprint for placement against the structure. The ends of the stabilizer may be aluminum, hard plastic, rubber or the like. While this larger footprint can help stabilize the ladder, sliding of the stabilizer along the side of the building can still occur. Moreover, if the ladder is offset slightly (that is, the axis of the ladder rungs are not parallel with the face of the building), the ends of the stabilizer or the ladder itself may not rest firmly and evenly against the building. Finally, stabilizers may still cause damage to the structure, as the ends of the stabilizer are frequently formed of a hard material.

When using a ladder, one person climbs the ladder while another person holds the ladder for stabilization. As the user climbs higher, the ladder becomes less and less stable, as the center of gravity of the user/ladder is getting higher and further away from the points of contact of the ladder to the ground. Many times, a second person is not available to assist a person climbing the ladder.

As can be seen, there is a need for devices to help protect the structure upon which the ladder is placed.

### BRIEF DESCRIPTION OF THE DRAWINGS

FIG. 1 is a side view of a ladder boot disposed on one end of the rails of a ladder according to an exemplary embodiment of the present invention;

FIG. 2 is a top perspective view of a ladder having a ladder stabilizer having a ladder boot on each end thereof, according to an exemplary embodiment of the present invention;

FIG. 3 is a front view of a ladder using the ladder boot, as shown in FIG. 1, further utilizing a ladder protection pad according to a further embodiment of the present invention;

FIG. 4 is an exploded view of the ladder protection pad of FIG. 3;

FIG. 5 is a front view of a ladder using the ladder boot and ladder protection pad, as shown in FIG. 3, further including an accessory pouch, according to an exemplary embodiment of the present invention;

FIG. 6 is a front view of a ladder having a through-rung weight disposed therein, according to an exemplary embodiment of the present invention;

FIG. 7 is a front view of the through-rung weight of FIG. 6;

FIG. 8 is a front view of a ladder having a rung-attached weight disposed therein, according to an exemplary embodiment of the present invention; and

FIG. 9 is a perspective view of a ladder protection pad with ladder rail receiving pockets according to another exemplary embodiment of the present invention.

### SUMMARY OF THE INVENTION

In one aspect of the present invention, a method for using a ladder comprises attaching a ladder boot to opposite structure contacting portions of the ladder, the ladder boot having a deformable material encased within an outer layer, the outer layer having a slip-resistant outer surface; and placing the ladder against a structure, where the ladder boots contact the structure.

In another aspect of the present invention, a method for using a ladder comprises attaching one or more weights to a lower portion of the ladder; and placing the ladder against a structure, where the ladder boots contact the structure.

In a further aspect of the present invention, a method for using a ladder comprises attaching a ladder boot to ends of each rail of the ladder, the ladder boot having a deformable material encased within an outer layer, the outer layer having a slip-resistant outer surface; attaching one or more weights to a lower portion of the ladder; and placing the ladder against a structure, where the ladder boots contact the structure.

These and other features, aspects and advantages of the present invention will become better understood with reference to the following drawings, description and claims.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention include mitts or boots or pads are formed from a deformable material, such as foam and/or memory foam and/or gel filled for more protection of walls. When the mitts are disposed on the ends of the rails of the ladder, and the ladder is placed against a wall or building exterior, the mitts help prevent damage to the wall or building by the ladder. The ladder can help prevent damage to various surfaces, such as acrylic stucco, aluminum or vinyl siding, aluminum window and fascia capping, gutters, soft wood such as cedar, sheetrock, painted or stained surfaces, and the like. The mitts can include an outer covering with enhanced friction properties, such a rubber, that can help grip the structure upon which the ladder is placed. The center of gravity of the ladder can be further lowered with weights attached to a lower rung of the ladder.

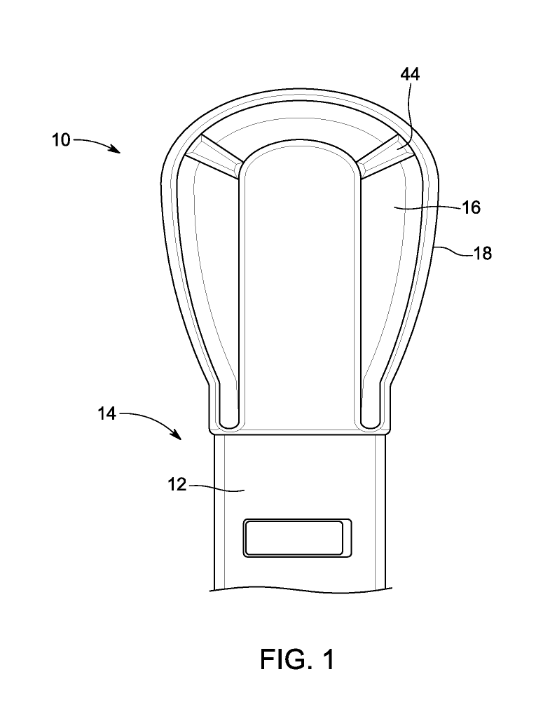

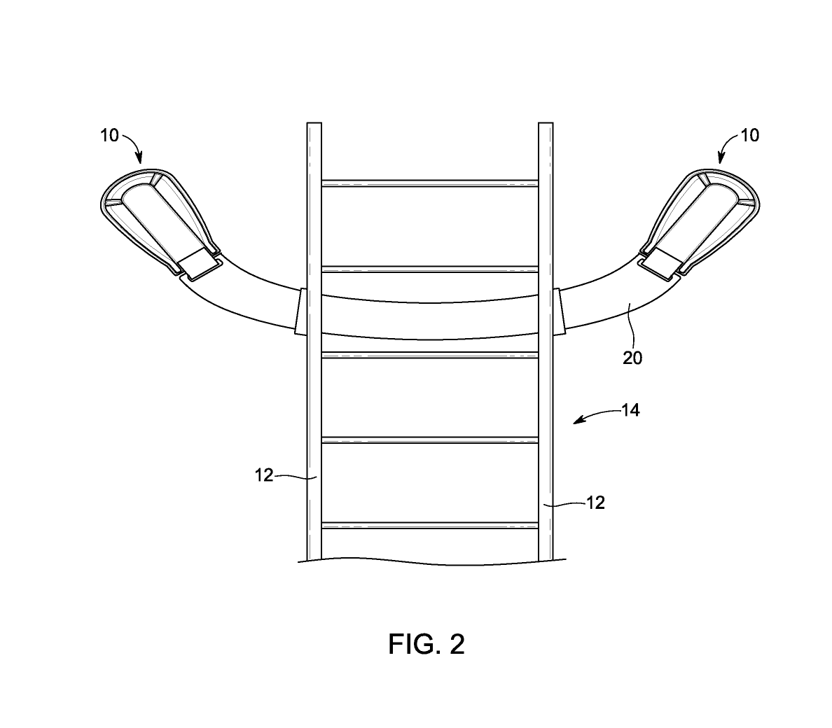

Referring now to FIGS. 1 through 3, a ladder boot 10 (also referred to a ladder mitt 10) can be placed over the ends of rails 12 of a ladder 14. The ladder boot 10 can be formed from a deformable material 16, such as foam, memory form, gel, or the like. In some embodiments, the deformable material 16 can be covered with an outer material 18, such a rubber. Typically, the outer material 18 can be chosen with an enhanced friction, where enhanced refers to an increased friction as compared to the ends of the ladder when not covered with the ladder boot 10. In some embodiments, the outer material 18 can be textured to further enhance the friction properties of the outer material with a surface upon which the ladder is placed. This design can help prevent the ladder from sliding along the side of the structure should a user on the ladder shift their weight to one side, for example. Further, the ladder boot 10 can help in the placement of the ladder when the ladder is not perfectly square to the structure (that is, the axis of the rung of the ladder is not exactly parallel to the surface of the structure), as one ladder boot 10 can be deformed a greater amount than the opposite ladder boot, but both ladder boots 10 are still firmly pressed against the structure. While the ladder boots may help solve some ladder stabilization issues, the ladder should still be used according to manufacturer's recommended usage and safety instructions.

The ladder boot 10 may be designed to fit not only the ends of the rails 12 of the ladder 14, but may also fit on the ends of a ladder stabilizer 20. In any event, the ladder boot 10 may be disposed on a structure contacting portion of the ladder, where the structure contacting portion may be the ends of the rails of the ladder, or a ladder stabilizer, depending upon the configuration of the ladder.

The ladder boot 10 can include a strap 22 that can be attached to and extend from the ladder boot 10. The strap 22 can extend about a top rung 24 of the ladder 14 to prevent the ladder boot 10 from being inadvertently removed from the rails 12 of the ladder 14.

In some embodiments, the ladder boot 10 can include an inner stabilization material 44 that can extend from an inside of the ladder boot 10 toward an outside thereof. The inner stabilization material 44 can be chosen to be less deformable than the deformable material 16. In some embodiments, an inside metal plate can be disposed behind the pad—so ladder rests on it and the deformable material has backing.

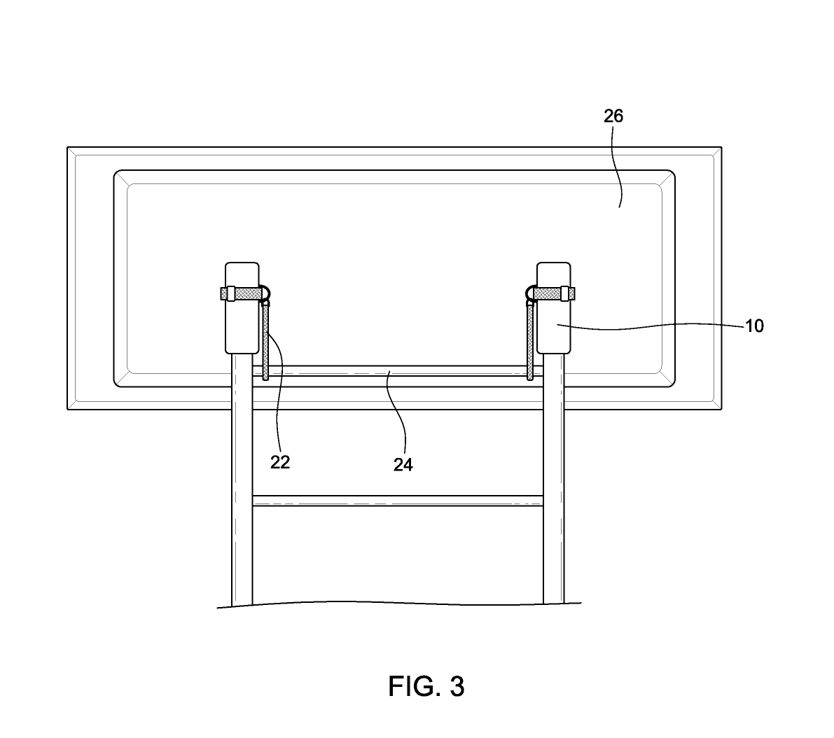

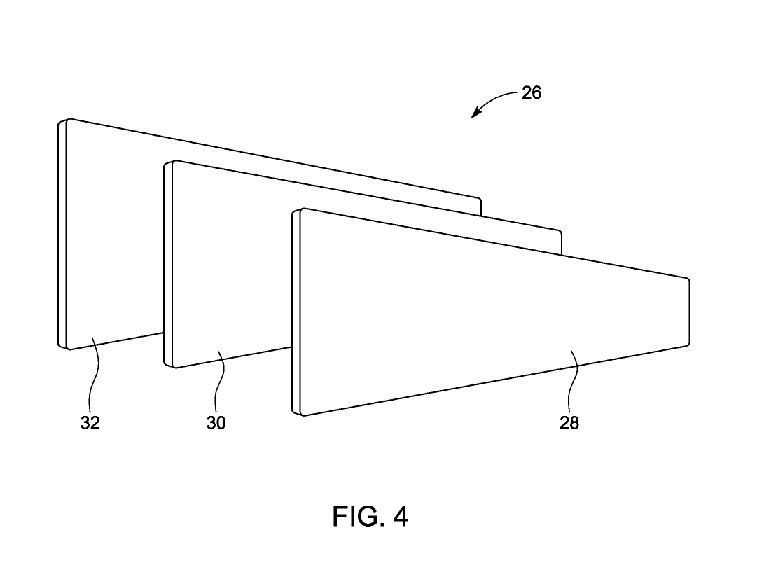

Referring to FIGS. 3 and 4, the ladder boot 10 may be used with a ladder protection pad 26. The ladder protection pad 26 can be formed from multiple layers. For example, an outer layer 28 may be made of metal, plastic, or the like. Behind the outer layer 28 may be a deformable layer 30, formed from gel, foam, or the like. The back layer 32 may be a high friction layer formed from, for example, rubber. As shown in FIG. 3, in use, the ladder protection pad 26 may be placed against the building (on the back layer 32 side) and the ladder 14 (or the ladder boots 10) may rest against the outer layer 28 thereof. The ladder protection pad 26 can be made in various sizes. While the Figures show the ladder protection pad 26 extending just beyond the ladder rungs, in some embodiments, the ladder protection pad 26 could be larger for added stabilization and additional wall protection.

In some embodiments, the ladder protection pad 26 may be connected to the ladder boots 10 so that the ladder protection pad 26 can be placed before placing the ladder against the structure. The ladder protection pad 26 can attach to the ladder boots 10 by various means as may be known in the art.

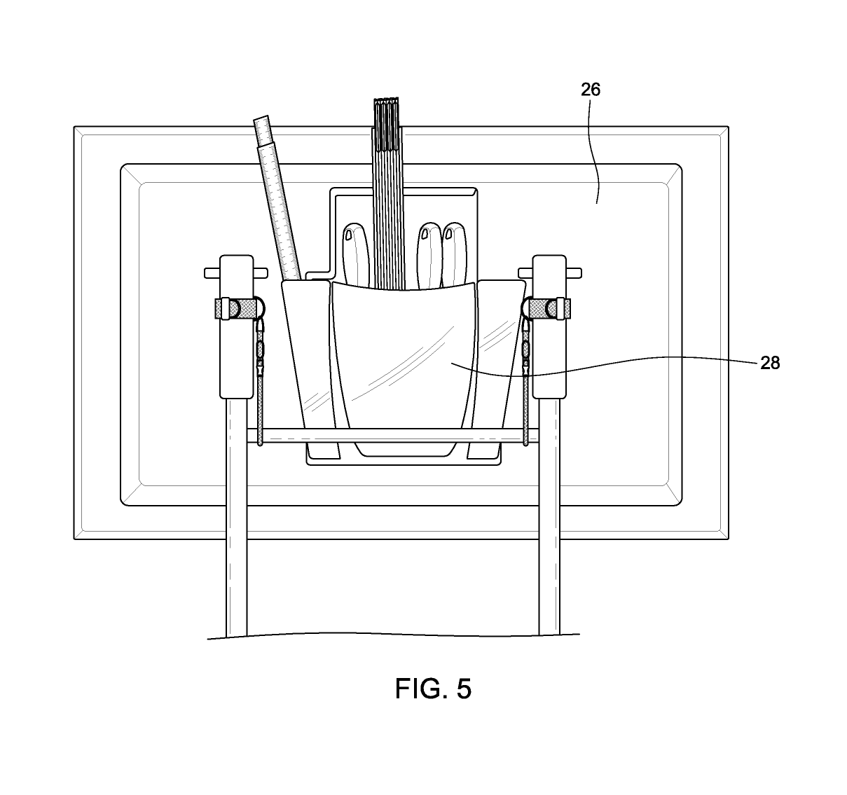

In some embodiments, as shown in FIG. 5, the ladder protection pad 26 can include one or more pouches 28. The pouches 28 may be attached to or formed integrally with the ladder protection pad 26. The pouches 28 may be useful for holding various items, such as tools, fasteners, beverages, or the like.

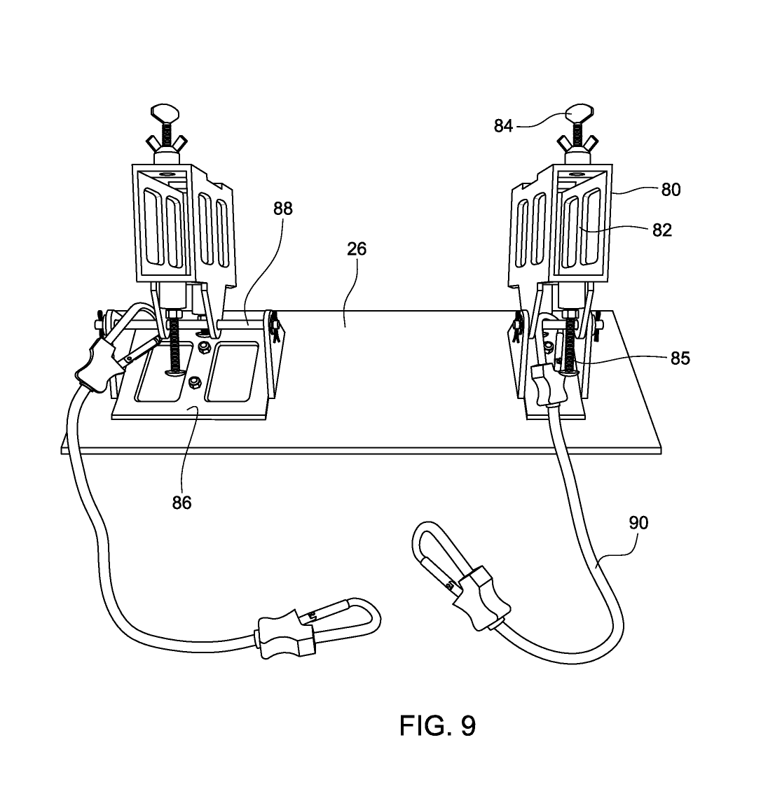

As shown in FIG. 9, the ladder protection pad 26 could attach to the ladder with rail pockets 80 having a central region 82 for receiving the ends of the ladder rails therein. The rail pockets 80 may pivot on a rod 88 that is attached to a mount 86. The mount 86 may attach to a back side (that is, the side not facing the building) of the ladder protection pad 26. The rail pockets 80 may also be horizontally movable (along the rod 88) to fit on ladders having various spacing between the side rails. In some embodiments, a turn screw 84 may be disposed on one or more sides of the rail pockets 80 for securing the rail pockets 80 to the ladder rails. Even with the rail pockets 80 tightened against the ladder rails, the ladder protection pad 26 may still pivot (due to the rail pockets 80 being pivotably mounted on the rods 88), allowing the ladder to be placed, with the ladder protection pad 26, against a building at various angles, if so desired. The amount of pivot may be limited by an adjustable limit screw 85 which can limit the minimum angle of the ladder on the building.

Straps 90 may extend from the mount 86, or from the rod 88, to help secure the ladder protection pad 26 to the end of the ladder. The straps 90 may have various connectors, such as hooks, carabineers, or the like, on one or both ends thereof.

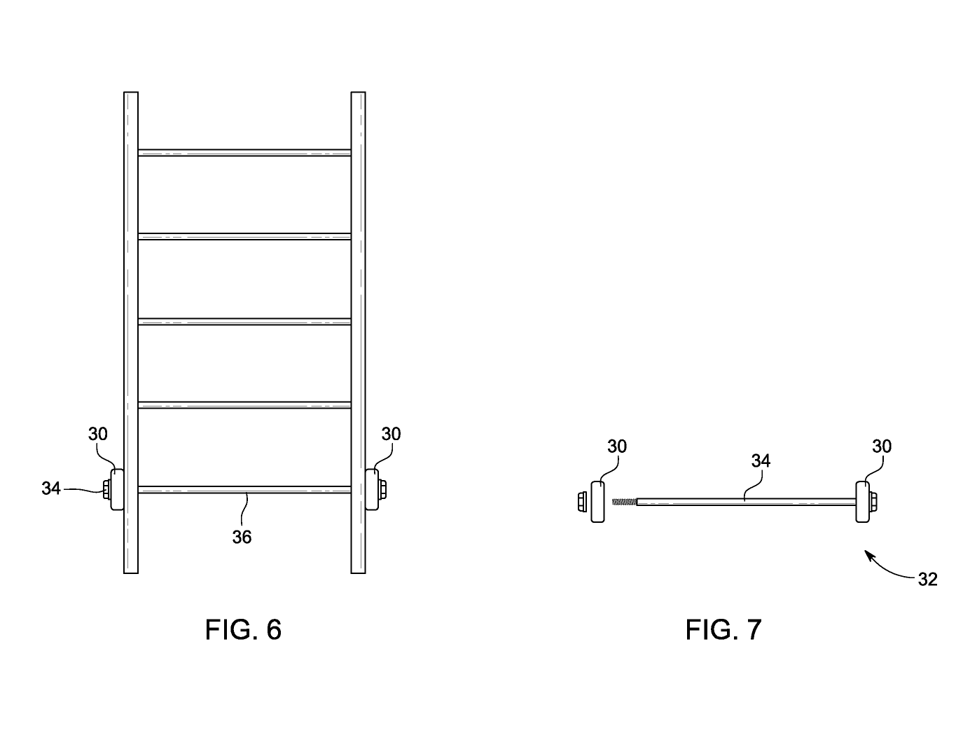

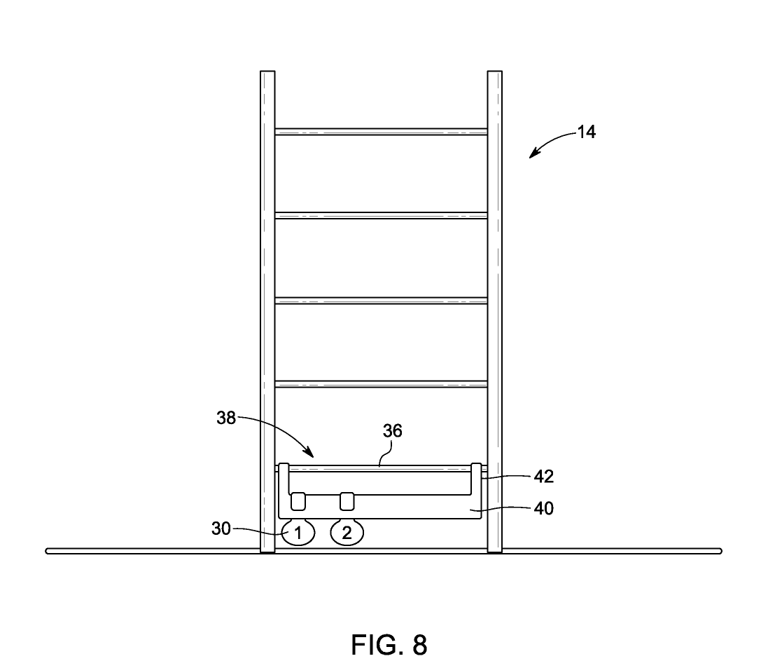

Referring now to FIGS. 6 through 8, the center of gravity of the ladder 14 can be lowered by the addition of one or more weights 30 disposed toward a bottom end of the ladder. In some embodiments, a through-rung weight system 32 can include a rod 34 having the weights 30 on each end thereof. To use the through-rung weight system 32, the user can remove one of the weights 30 off one end of the rod 34, slide the rod through a lower rung 36 (typically, the bottom rung) of the ladder 14, and reattach the removed weight back on the rod 34. In an alternative embodiment, a rung-attached weight system 38 can include a weight support 40 that attaches to the lower rung 36 of the ladder 14. The weight support 40 can be attached in various manners, such as with straps 42. The weights 30 can then be attached to the weight support 40, as shown in FIG. 8. The weights 30 can be, for example, from about 2 to about 25 pounds.

Regardless of configuration, the addition of additional weight toward the base of the ladder (such as on the bottom rung) can lower the center of gravity of the ladder with the user climbing thereupon. This lowered center of gravity helps stabilize the ladder and can minimize the effect of a user shifting their weight while on an upper rung of the ladder. The base weights can also help stabilize the ladder when used in windy conditions. Of course, proper precautions should still be taken on the ladder, even with the additional stabilization.

It should be understood, of course, that the foregoing relates to exemplary embodiments of the invention and that modifications may be made without departing from the spirit and scope of the invention as set forth in the following claims.

What is claimed is:

1. A method for stabilizing a ladder comprising:
attaching a ladder boot to opposite structure contacting portions of the ladder, the ladder boot having a deformable material encased within an outer layer, the outer layer having a slip-resistant outer surface; and
placing the ladder against a structure, where the ladder boots contact the structure.

2. The method of claim 1, wherein the structure contacting portions are ends each rail of the ladder.

3. The method of claim 1, wherein the structure contacting portions are ends of a ladder stabilizer attached to the ladder.

4. The method of claim 1, wherein the deformable material is selected from the group consisting of foam, memory form and gel.

5. The method of claim 1, wherein the slip-resistant outer layer is rubber.

6. The method of claim 1, further comprising limiting deformation of the deformable material by disposing an inner stabilization material within the outer layer.

7. The method of claim 2, further comprising extending straps from the ladder boots around an upper rung of the ladder to secure the ladder boot to the rails.

8. The method of claim 1, further comprising attaching one or more weights to a lower portion of the ladder.

9. The method of claim 8, wherein the one or more weights attach to a rod extending through a lower rung of the ladder.

10. The method of claim 8, wherein the one or more weights attach to a weight support extending from a lower rung of the ladder.

11. The method of claim 1, further comprising disposing a ladder protection pad between the ladder boot and the structure.

12. The method of claim 12, wherein the ladder protection pad includes a top surface, a deformable inner surface, and a bottom, slip resistant surface.

13. The method of claim 11, further comprising storing items in a pouch attached to the top surface of the ladder protection pad.

14. A method for stabilization of a ladder comprising:
attaching a ladder boot to ends of each rail of the ladder, the ladder boot having a deformable material encased within an outer layer, the outer layer having a slip-resistant outer surface;
attaching one or more weights to a lower portion of the ladder; and
placing the ladder against a structure, where the ladder boots contact the structure.

15. The method of claim 14, further comprising extending straps from the ladder boots around an upper rung of the ladder to secure the ladder boot to the rails.

16. The method of claim 14, further comprising disposing a ladder protection pad between the ladder boot and the structure, wherein the ladder protection pad includes a top surface, a deformable inner surface, and a bottom, slip resistant surface.

17. A method for stabilization of a ladder comprising:
attaching one or more weights to a lower portion of the ladder; and
placing the ladder against a structure, where the ladder boots contact the structure.

18. The method of claim 17, further comprising:
attaching a ladder boot to ends of each rail of the ladder, the ladder boot having a deformable material encased within an outer layer, the outer layer having a slip-resistant outer surface, wherein the deformable material is selected from the group consisting of foam, memory form and gel.

19. The method of claim 17, wherein the one or more weights attach to a rod extending through a lower rung of the ladder.

20. The method of claim 17, wherein the one or more weights attach to a weight support extending from a lower rung of the ladder.
